(19) United States
(12) Patent Application Publication
(10) Pub. No.: US 2009/0128417 A1
(43) Pub. Date: May 21, 2009

(54) ELECTROLESS/ELECTROLYTIC SEED LAYER PROCESS

(75) Inventor: Robert R. Oberle, Macungie, PA (US)

Correspondence Address: FLIESLER MEYER LLP, 650 CALIFORNIA STREET, 14TH FLOOR, SAN FRANCISCO, CA, 94108, US

(73) Assignee: RCD TECHNOLOGY, INC., Quakertown, PA (US)

(21) Appl. No.: 12/131,771

(22) Filed: Jun. 2, 2008

Related U.S. Application Data
(60) Provisional application No. 60/988,655, filed on Nov. 16, 2007.

(51) Int. Cl. H01Q 9/04; C25D 5/02

(52) U.S. Cl. 343/700 MS; 205/122

(57) ABSTRACT

An electroless metallization catalyst layer can be formed in a RFID antenna pattern. A first metallic layer can be deposited over top of the electroless metallization catalyst layer. An electrical short layer connecting regions of the metallic layer can be formed. A portion of electrical short layer can be covered with a non-conductive layer. The first metallic layer can be electroplated with a second metallic layer.

### CLAIM OF PRIORITY

This application claims priority to U.S. Provisional Application No. 60/988,655 entitled “ELECTROLESS/ELECTROLYTIC SEED LAYER PROCESS” filed Nov. 16, 2007, which is incorporated herein by reference (Atty. Docket No. RCDT-01020US0).

### BACKGROUND OF THE INVENTION

The present invention relates to methods of manufacture of flexible circuits used in construction of Radio Frequency (RF) antennae.

Radio frequency antennae are typically made in a conductive coil pattern. The conductive coil pattern allows the antenna to receive and radiate energies in the radio frequency range. Typically, the antenna is optimized to transmit and receive energy in a relatively narrow portion of the radio frequency range.

Radio frequency antennae are used in a number of different areas including inventory control. Often the radio frequency antenna is connected to an integrated circuit. The integrated circuit receives energy from a detector unit, modulates the energy with an identification pattern stored in the integrated circuit, and then retransmits the modulated energy to the detector unit. Such inventory control units, including the radio frequency antennae, can be made quite inexpensively.

One way of forming a radio frequency antenna is to stamp out a conductive coil out of a sheet of metal. The downside of this method is that the production of the metal coil results in a large amount of scrap metal. Additionally, the radio frequency antennae produced by stamping from a sheet of metal may be stiffer than desired.

Another way of forming the radio frequency antenna is to use strip-back techniques common in printed circuit (PC) board fabrication. In PC board fabrication, a layer of the conductive material is formed on top of a substrate, and the areas not used for the antenna are stripped away. This method tends to be wasteful when used to produce the radio frequency antenna, because the radio frequency coil antenna tends to be about 10% of the surface area of the substrate. This compares to coverage areas of 70-80% common with typical PC board implementations.

Another way of forming a radio frequency antenna is to use conductive inks. Typically, the conductive ink is printed in a RF antenna coil pattern on top of the substrate. The conductive ink is then cured. The printed antennae may be used as is or electrodes are attached to the conductive ink pattern and a metal layer is electroplated on top of the conductive ink pattern. FIG. 1 illustrates this prior art embodiment. The electrode is attached pad 22 to electroplate the metal material on top of the conductive ink pattern. Because of its cost, the conductive ink material tends to be applied in relatively narrow and thin layers. This means that when a voltage source is attached to pad 22, there is considerable electrical resistance between pad 22 and point 24 near the center of the pattern. Due to this electrical resistance, the electroplated material preferentially coats the areas near the electrode at pad 22, rather than position 24. This makes it difficult to obtain a proper electroplated coating on top of the conductive ink.

One possible solution is to use the conductive ink with a thicker or wider pattern, thus reducing the resistance per length of the conductive ink strip. The downside of this solution is that the conductive ink is expensive compared to the much cheaper electroplated material.

For the above reasons, it is desired to have an improved method of forming a radio frequency antenna.

### BRIEF DESCRIPTION OF THE DRAWINGS

FIG. 1 shows a prior art RFID antenna.

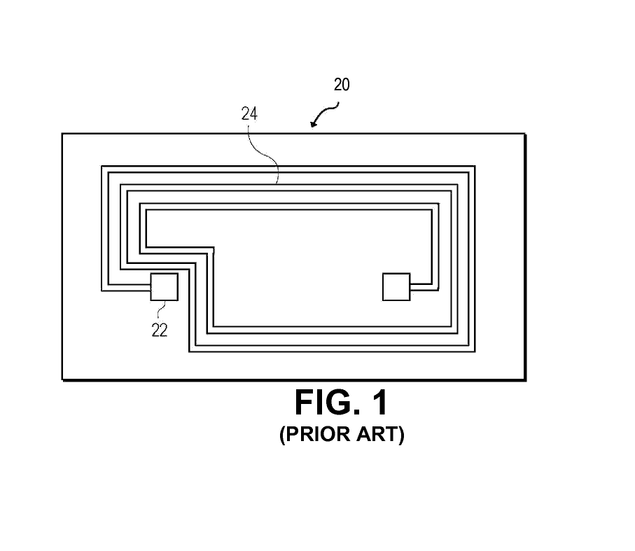

FIG. 2 illustrates a method of forming a RFID antenna.

FIG. 3 is a top view of a RFID antenna constructed by a method of the present invention.

FIG. 4 is a detail of FIG. 3.

FIGS. 5A-5F are cross sectional views illustrating the construction of one embodiment of a RFID antenna of one embodiment.

### DETAILED DESCRIPTION OF THE PRESENT INVENTION

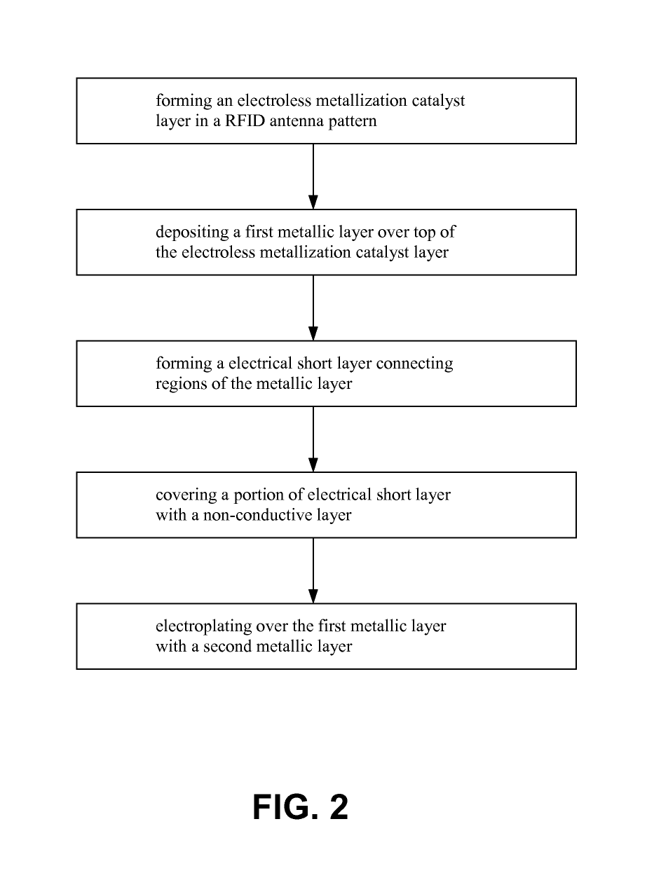

FIG. 2 illustrates a method of forming a RFID antenna. In step 202, an electroless metallization catalyst layer is formed in a RFID antenna pattern. In step 204, a first metallic layer is deposited over top of the electroless metallization catalyst layer. In step 206, an electrical short layer connecting regions of the metallic layer is formed. In step 208, a portion of electrical short layer is covered with a non-conductive layer; and in step 210, the first metallic layer is electroplated with a second metallic layer.

The method can further comprise removing at least a portion of the non-conductive layer and the printed short layer. The non-conductive layer can be a resist material.

The electrical short layer can be made of conductive ink that can be printed.

The electroless metallization catalyst layer can be formed by printing using an ink. The ink can be cured before the first metallic layer is deposited.

The ink can be treated to activate catalyst in the electroless metallization catalyst layer before the first metallic layer is deposited.

The first and second metallic layers can be copper layers.

The electroless metallization catalyst layer can be formed by removing some of the electroless metallization catalyst material.

A negative resist layer can be used to remove some of the electroless metallization catalyst material.

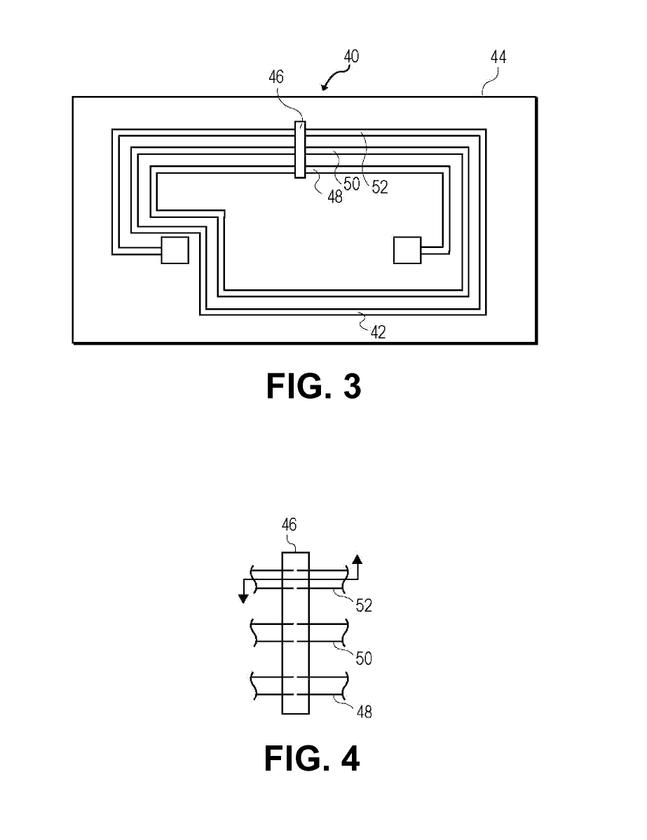

FIG. 3 is a top view of a radio frequency antenna 40 being constructed by the method of one embodiment of the present invention. The radio frequency antenna 40 includes an electroless 42 formed on the substrate 44. A first metallic layer can then be deposited over the electroless catalyzation layer. This can mean that a relatively thin conductive layer is being formed.

An electrical-short layer 46 can be formed over top of the antenna pattern, and a nonconductive plating resist can be formed over the short. The electrical-short layer 46 can ensure that points 48, 50 and 52 on the pattern 42 will have relatively similar voltages during the electroplating process. This means all locations on the conductive ink pattern 42 can be electroplated evenly. Thus the apparatus of the present invention allows for a conductive electroplate layer of sufficient thickness on all points of the radio frequency antenna.

The use of the electrical-short layer 46 allows for the use of a thinner and/or narrower pattern 42. The resistance of the pattern 42, during the electroplate process, is not as important of a factor because the electrical-short layer is used.

Typically it is desired to minimize the resistance of the radio frequency antenna. A desirable property of radio frequency antennae is to have a relatively high Q factor. The Q factor for an antenna is defined as the imaginary over the real part of the impedance. The imaginary part of the impedance is typically a function of the desired operating frequency and geometry and is typically fixed. Thus, to produce a high Q factor antenna, the resistance of the antenna should be kept as small as possible. This means that it is desired to have a relatively thick conductive metal layer forming the coils of the radio frequency antenna. The use of the electrical-short layer of the present invention aids in the construction of a uniformly thick electroplate layer, thus lowering the resistance and raising the Q factor.

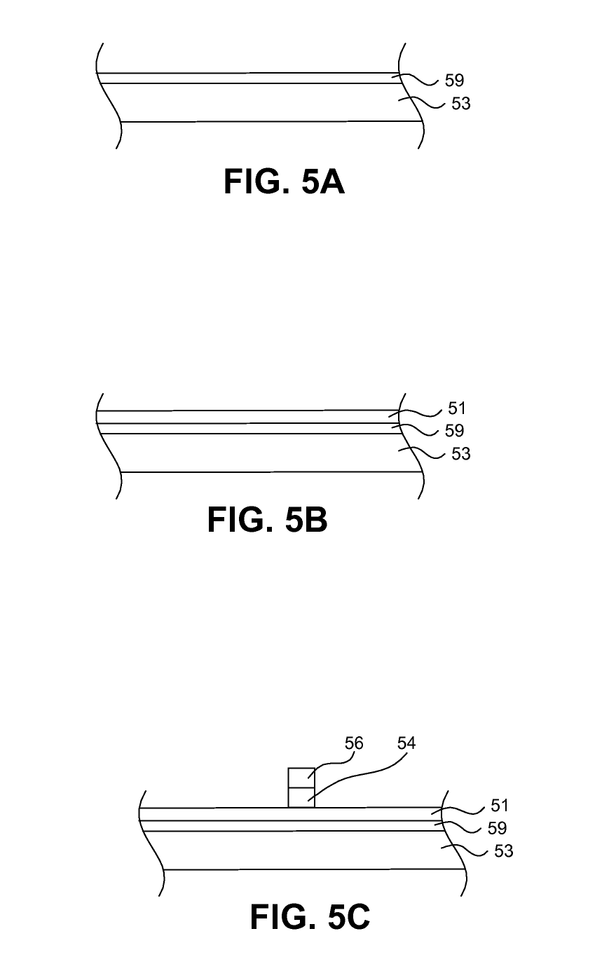

FIG. 4 is a detail of a portion of FIG. 3.

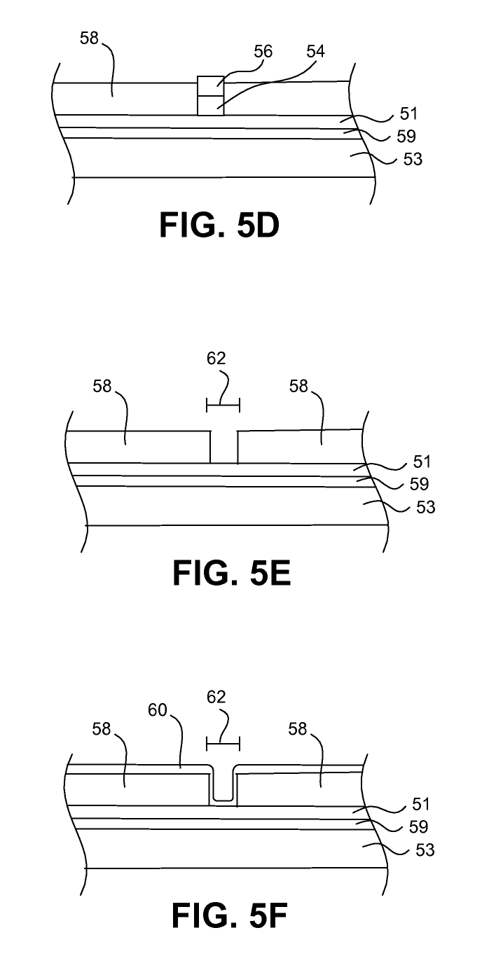

FIGS. 5A-5F are cross-sectional views illustrating the construction of one embodiment of the radio frequency antenna of the present invention.

In FIG. 5A, an electroless metallization layer 54 is formed on top of the substrate 52. In one embodiment, the substrate 52 is a flexible substrate which allows the constructed radio frequency antenna to bend. One example of a flexible substrate material which is suitable for use with the present invention is Mylar™, polyester film from E.I. DuPont de Nemours, Wilmington, Del. An electroless metallization catalyst 54 can be formed in an antenna pattern shown with respect to FIG. 2 above.

In FIG. 5B, a first metallization layer 51 can be formed on the electroless metallization catalyst. In FIG. 5C, the electrical-short layer material 54 can be formed over top of the coil pattern 50. The electrical short ink layer could be of the type such as EnTouch™ EN-081 from Engelhard Corporation Iselin N.J. An additional insulating layer 56 can be formed on top of the electrical-short layer 54. The insulating ink layer could be of the type such as EnTouch™ EN-080 from Engelhard Corporation Iselin N.J.

The electroless metallization catalyst layer 54 can be printed upon the flexible substrate. In one embodiment, the electrical-short layer 54, and the insulating layer, 56 are differentially removable (for example soluble in a solvent that the initial seed layer is impervious to) from the conductive ink material.

FIG. 5D illustrates the results of the electroplating, in which the second metallic layer 58 is formed over top of the first metallic layer 51. The insulating layer 50 can prevent an electroplate layer from forming on the electrical-short layer. The second metallic layer 58 is preferably an inexpensive metal material. In one embodiment of the present invention, the first and second metallic layers are made of copper.

In FIG. 5E, the electrical-short layer 54 and the insulating layer 56 are stripped away. The stripping can be done using a solvent, ashing, reactive gas or any other method.

In an alternate embodiment of the present invention, the electrical-short layer 54 is constructed of metallic foil, which could be attached to the RF antenna and then removed after the electroplating.

FIG. 5F shows an optional additional step of an additional electroplating in which an additional electroplate layer 60 is formed on top of the second metallic layer 58. The advantage of the second electroplate step is that it allows for some electroplate material to go into the removed short layer region 62.

One embodiment of the present invention is a RFID antenna comprising of an electroless metallization catalyst layer in an RFID antenna pattern. A first metallic layer can be over the top of the electroless metallization catalyst layer, the first metallic layer formed by electroless deposition. A second metallic layer can be over the top of the first metallic layer. The second metallic layer can be formed by electroplating the electroplating using a removed electrical short layer.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A method of forming a RFID antenna comprising:
forming an electroless metallization catalyst layer in a RFID antenna pattern;
depositing a first metallic layer over top of the electroless metallization catalyst layer;
forming an electrical short layer connecting regions of the metallic layer;
covering a portion of electrical short layer with a non-conductive layer; and
electroplating over the first metallic layer with a second metallic layer.

2. The method of claim 1, further comprising removing at least a portion of the non-conductive layer.

3. The method of claim 2, wherein at least a portion of the printed short layer is removed.

4. The method of claim 1, wherein the non-conductive layer is a resist material.

5. The method of claim 1, wherein the electrical short layer is made of conductive ink

6. The method of claim 1, wherein the electroless metallization catalyst layer is formed by printing using an ink.

7. The method of claim 6, wherein the ink is cured before the first metallic layer is deposited.

8. The method of claim 7, wherein the ink is treated to activate catalyst in the electroless metallization catalyst layer before the first metallic layer is deposited.

9. The method of claim 1, wherein the first metallic layer is a copper layer.

10. The method of claim 1, wherein the second metallic layer is a copper layer.

11. The method of claim 1, wherein the forming of electroless metallization catalyst layer can include removing some of the electroless metallization catalyst material.

12. The method of claim 11, wherein a negative resist layer is used to remove some of the electroless metallization catalyst material.

13. An RFID antenna comprises an electroless metallization catalyst layer in an RFID antenna pattern;
a first metallic layer over top of the electroless metallization catalyst layer, the first metallic layer formed by electroless deposition;
a second metallic layer over top of the first metallic layer, the second metallic layer formed by electroplating the electroplating using a removed electrical short layer.

14. The RFID antenna of claim 13, further comprising removing at least a portion of the non-conductive layer.

15. The RFID antenna of claim 14, wherein at least a portion of the printed short layer is removed.

16. The RFID antenna of claim 13, wherein the non-conductive layer is a resist material.

17. The RFID antenna of claim 13, wherein the electrical short layer is made of conductive ink.

18. The RFID antenna of claim 13, wherein the electroless metallization catalyst layer is formed by printing using an ink.

19. The RFID antenna of claim 18, wherein the ink is cured before the first metallic layer is deposited.

20. The RFID antenna of claim 19, wherein the ink is treated to activate catalyst in the electroless metallization catalyst layer before the first metallic layer is deposited.

21. The RFID antenna of claim 13, wherein the first metallic layer is a copper layer.

22. The RFID antenna of claim 13, wherein the second metallic layer is a copper layer.

23. The RFID antenna of claim 13, wherein the electroless metallization catalyst layer includes removing some of the electroless metallization catalyst material.

24. The RFID antenna of claim 23, wherein a negative resist layer is used to remove some of the electroless metallization catalyst material.
